(19) United States
(12) Patent Application Publication
(10) Pub. No.: US 2004/0031639 A1
(43) Pub. Date: Feb. 19, 2004

(54) Multi-function utiltiy vehicle

(75) Inventors: Thomas John Deves, Evans, GA (US); Roseann Bischof, West Bend, WI (US); Cindy Louise Weber, Cedarburg, WI (US); Clay David Brewer, Chambersburg, PA (US); Martin Walker Schramm, Williamsburg, VA (US); James Heinrich Weitz, Hoboken, NJ (US); Ryan D. Smieja, Williamsburg, VA (US)

Correspondence Address: POLIT & ASSOCIATES, L.L.C., 3333 WARRENVILLE ROAD, SUITE 520, LISLE, IL, 60532, US

(73) Assignee: Deere & Company

(21) Appl. No.: 10/218,983

(22) Filed: Aug. 14, 2002

(51) Int. Cl. B62D 21/00

(52) U.S. Cl. 180/311

(57) ABSTRACT

A multi-function utility vehicle has a structure and mechanism which allows the vehicle to carry people on a rear-facing seat, and which can quickly and easily be converted to carry cargo on a rear cargo area floor and at the same time carry vertically oriented cargo, such as garbage cans or golf bags, or can be quickly converted for carrying long horizontally oriented cargo. The conversions can be accomplished without removing or adding equipment, and without using tools. A rear mounted cargo area includes a horizontal seat and an associated seatback. The seatback is pivotal to be folded down onto the seat, and the seat and seatback are pivotal about 90 degrees to form a cargo restraining structure, and about 180 degrees to form an extended floor.

### TECHNICAL FIELD OF THE INVENTION

The present invention relates to small powered vehicles or carts that can be used for hauling cargo, or transporting people, or transporting people and golf bags.

### BACKGROUND OF THE INVENTION

Utility vehicles, such as the John Deere GATOR®, are known which are adapted to be used in off-road conditions. Such vehicles include an operator's seat and a cargo area behind the operator's seat.

Small vehicles or carts are also known for use in carrying golf bags. In a typical golf cart a front bench seat can hold a driver and a passenger next to the driver. A vertical golf bag support wall or restraining structure is located behind the passengers.

It is also known for small vehicles or carts to provide a rear-facing seat wherein the rear-facing seat can also be folded down to provide a cargo-holding platform.

Small carts are known which have a cargo area for cargo, or have provision to carry extra passengers, or can be set up to carry golf clubs; but none of the known carts are capable of doing all these functions without disassembly or modification. This requires either multiple vehicles for multiple functions, or time-consuming change-overs between cargo areas and golf bag carriers and people carriers.

The present inventors have recognized that people desire to utilize a utility vehicle for multiple uses. The present inventors have recognized the desirability of providing a utility vehicle having multiple functions. The present inventors have recognized the desirability of providing a utility vehicle that can be used to carry golf bags or other vertically oriented cargo, can be used as an open back hauler, and can be used as a people transporting car having a rear-facing seat. The present inventors have recognized the desirability of providing a multifunction vehicle that can be converted from one function to another without the necessity of spare parts or tools to undertake the conversion.

### SUMMARY OF THE INVENTION

The multi-function utility vehicle of the present invention has a unique structure and mechanism which allows the vehicle to carry people on a rearfacing seat, and which can quickly and easily be converted to carry cargo on a rear cargo area floor and at the same time carry vertically oriented cargo, such as garbage cans or golf bags, or can be quickly converted for carrying long horizontally oriented cargo such as garden tools, a fence post or lumber.

One advantage of the preferred embodiment of the invention is that the conversions can be accomplished without removing or adding equipment, and without using tools. The conversion requires no extra power, such as electric or hydraulic actuators.

The rear-facing seat can be configured to enhance rider comfort by use of a seat suspension. The seat suspension improves comfort on rough terrain. The people carrier position provides convenient handholds and foot support to be ergonomically comfortable. A support bar extends vertically from the foot platform. The support bar can be used by a person for support when entering or exiting the rear-facing seat.

The cargo area is pivotally mounted to the foot platform in order to tilt to a “dump” orientation, as well as to service vehicle components under the cargo area.

The preferred embodiment of the invention provides a utility vehicle that includes a chassis, a powertrain, and a plurality of wheels, at least one of which is driven by the powertrain. A rear mounted cargo area is convertible to multiple configurations including: a horizontal seat and an associated seatback, an open top enclosed floor for supporting cargo, a restraining structure for cargo to prevent tipping of the cargo, and an open top, open back cargo area with an extended floor. The seatback is pivotal to be folded down onto the seat, and the seat and seatback are pivotal about 90 degrees to form a cargo-restraining structure for restraining cargo from tipping, and pivotal about 180 degrees to form the extended floor. When the seat and seatback are pivoted about 90 degrees, the open top enclosed cargo holding area is formed in front of the cargo-restraining structure. The open top, open back extended floor configuration can also be used to assist in loading cargo into the cargo area, obviating the need to lift the cargo over a sidewall of the cargo area. Also, when the cargo area is tilted to the dump orientation, the open back allows materials within the cargo area to be more easily removed.

The seat is hinged to the floor along a rear end portion of the floor. The seatback is hinged to the seat. When the seat and seatback are rotated together about 90 degrees, the floor is exposed within the cargo area. A bottom surface of the seat, when rotated about 180 degrees from the normal seating position, comprises an extension of the floor. A front surface of the seatback, when rotated about 180 degrees from the normal seating position, can comprise a contoured golf bag supporting surface and further comprises golf bag-restraining straps engaged to the supporting surface.

A foot platform is arranged adjacent to the cargo area, below the seat adjacent to a rear end portion of the vehicle. A skirt panel extends substantially vertically from the foot platform up to the cargo area floor.

According to the invention, a method is provided of converting a rear-facing seat of a utility vehicle to multiple uses. The method comprises the steps of: providing a normally horizontal seat with a normally rear-facing seatback; folding the seatback down on the seat and folding up the seat and seatback together about 90 degrees to expose a floor area; locking the seat and seatback at about 90 degrees and providing at least one cargo-restraining strap on a rearward facing side of the seatback; and then folding the seat and seatback down in a direction away from the floor to orient a backside of the seat horizontally facing upwardly to form an extension to the floor.

A utility vehicle of the invention provides a three-position seat assembly wherein the seat assembly is pivotal from a first position forming a rearward-facing seat arrangement, to a second position forming a cargo-retaining wall, and to a third position forming an extended floor. When the seat arrangement is in the second position, an enclosed, open top cargo area is formed adjacent to the cargo-retaining wall.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a perspective view of a utility vehicle in accordance with the present invention illustrating a rear portion of the vehicle in a seating configuration;

FIG. 2 is a perspective view of the rear portion shown in FIG. 1 with the seat removed to show underlying structure;

FIG. 2A is a sectional view of the seat cushion taken generally along line 2A-2A of FIG. 1;

FIG. 3 is a perspective view of the rear portion shown in FIG. 1 illustrating a seatback being partially folded onto the seat;

FIG. 4 is a perspective view of the rear portion shown in FIG. 3 with the seatback completely folded down onto the seat;

FIG. 5 is a perspective view of the rear portion of FIG. 4 with the seat and seatback pivoted together a partial rotation;

FIG. 6 is a perspective view of the rear portion shown in FIG. 5 with the seat and seatback pivoted to a vertical position;

FIG. 7 is a perspective view of the rear portion shown in FIG. 6 with the seat and seatback pivoted a further partial rotation;

FIG. 8 is a perspective view of the rear portion shown in FIG. 7 with the seat and seatback pivoted completely to a horizontal orientation;

FIG. 9 is a sectional view of a latching arrangement as taken generally along line 9-9 of FIG. 2;

FIG. 9A is an enlarged fragmentary perspective view taken from FIG. 2;

FIG. 10 is a sectional view of a latching arrangement as taken generally along line 10-10 of FIG. 4;

FIG. 11 is a sectional view of a latching arrangement as taken generally along line 11-1 1 of FIG. 6;

FIG. 11A is an enlarged, fragmentary perspective view taken from FIG. 6;

FIG. 12 is a sectional view of a latching arrangement as taken generally along line 12-12 of FIG. 8;

FIG. 13 is an enlarged, fragmentary perspective view of the cargo area in the position shown in FIG. 11;

FIG. 14 is a fragmentary rear perspective view of the foot platform as shown in FIG. 2;

FIG. 15 is a front perspective view of a foot platform shown in FIG. 14.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

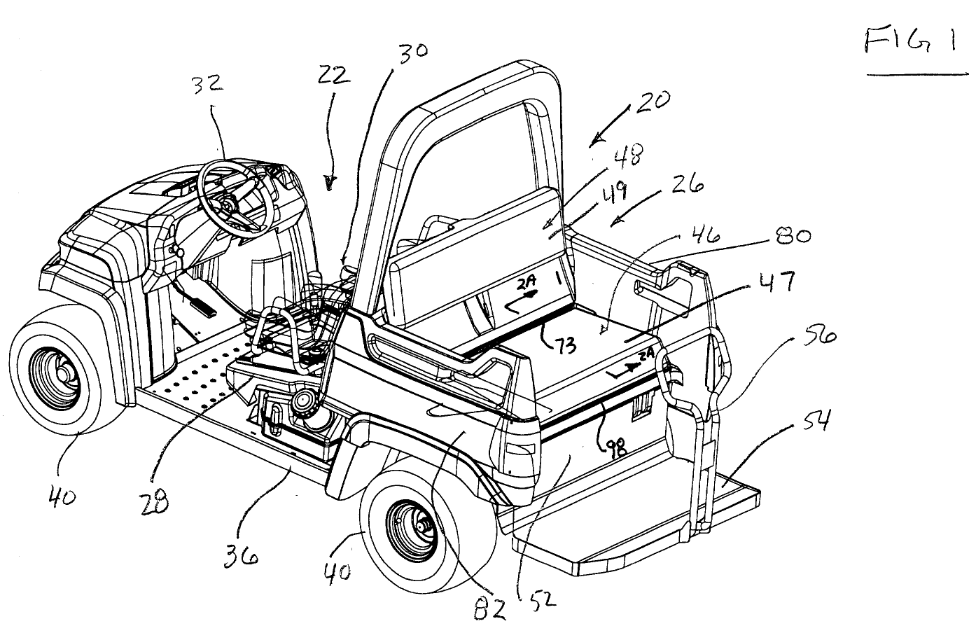

FIG. 1 illustrates a utility vehicle 20 in accordance with the present invention. The utility vehicle 20 includes a front driver's area 22 and a cargo area 26. The cargo area 26 can be in the form sometimes referred to as a “cargo box”. The front driver's area 22 includes a front seat 28, controls 30 and a steering wheel 32. The driver's area 22 and a cargo area 26 are mounted on a chassis 36 which is carried on four wheels 40. A powertrain (not shown) is carried by the chassis 36 and can include a motor, such as an internal combustion engine or an electric motor, a transmission, and a differential as applicable.

The cargo area 26 includes a seat 46 and an associated seatback 48. The seat 46 can include a seat cushion 47. The seatback 48 can include a seatback cushion 49.

A foot platform 54 is mounted to the chassis 36 rearward of the cargo area 26. A skirt panel 52 extends substantially vertically downward from the seat 46 to the foot platform 54. A support bar 56 extends vertically from the foot platform 54. A person sitting on the seat 46 can rest his or her feet on the foot platform 54. The support bar 56 can be used by a person for support during ingress and egress from the cargo area 26.

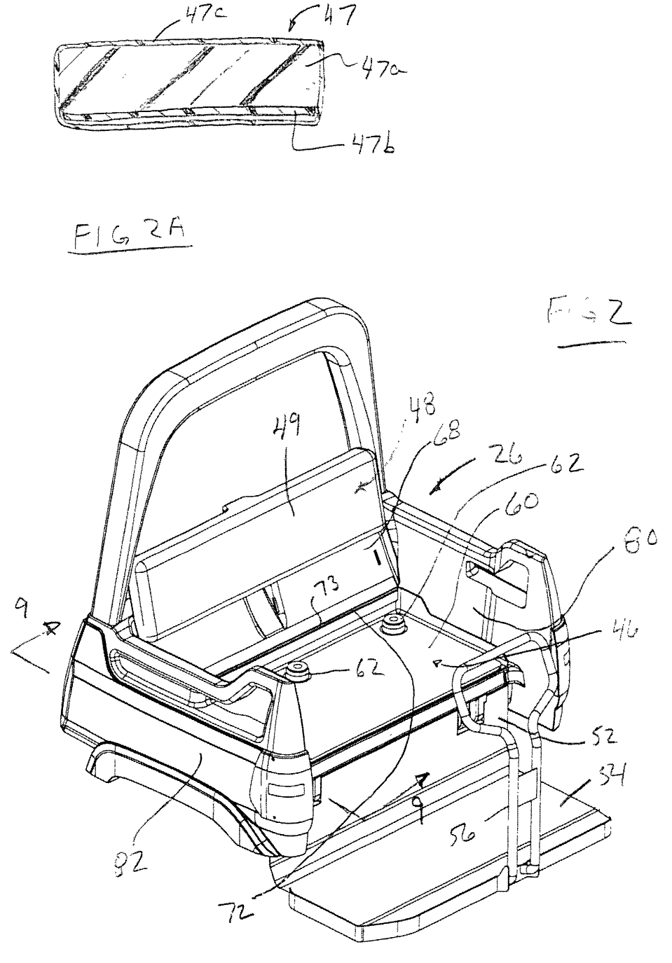

FIG. 2 illustrates the cargo area 26 with the seat cushion 47 removed to show the underlying structure of the seat 46. A seat support platform or support frame 60 underlies the seat cushion 47. A variety of resilient supports 62 are carried by the platform below the seat cushion 47. The resilient support 62 can be elastomeric bumpers, dampers, coil springs or other springs, or combinations of these elements.

As illustrated in FIG. 2A, the seat cushion 47 comprises a resilient cushion layer 47a resting on a board 47b, all covered by a skin or fabric 47c. According to one aspect of the invention, the board 47b is a ⅜ inch recycled polyethylene board. The board 47b is more resistant to rot than the heretofore known wooden boards.

The seatback cushion 49 is attached to a support panel or seatback frame 68. The support panel 68 is hinged along a hinge line 72 to the support platform 60. Preferably, the support panel 68 is hinged by a plastic living hinge 73 to the platform 60. The living hinge 73 can be a separate plastic strip and can extend across the width of the support panel 68 and can be secured to the support panel 68 and platform 60 by fasteners (not shown) The platform 60 and the support panel 68 are both located between sidewalls 80, 82 of the cargo area 26.

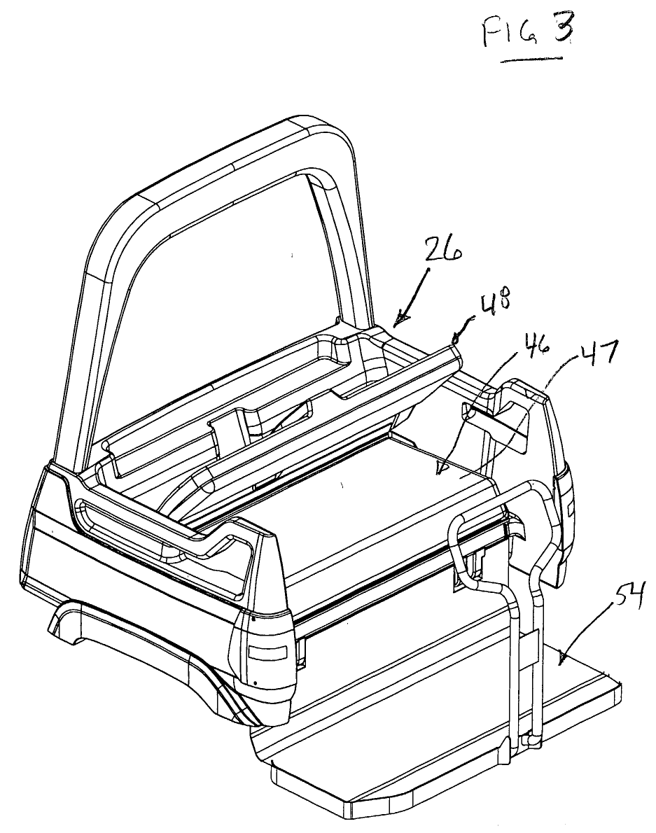

FIG. 3 illustrates the seatback 48 released and pivoted partially downward onto the seat cushion 47.

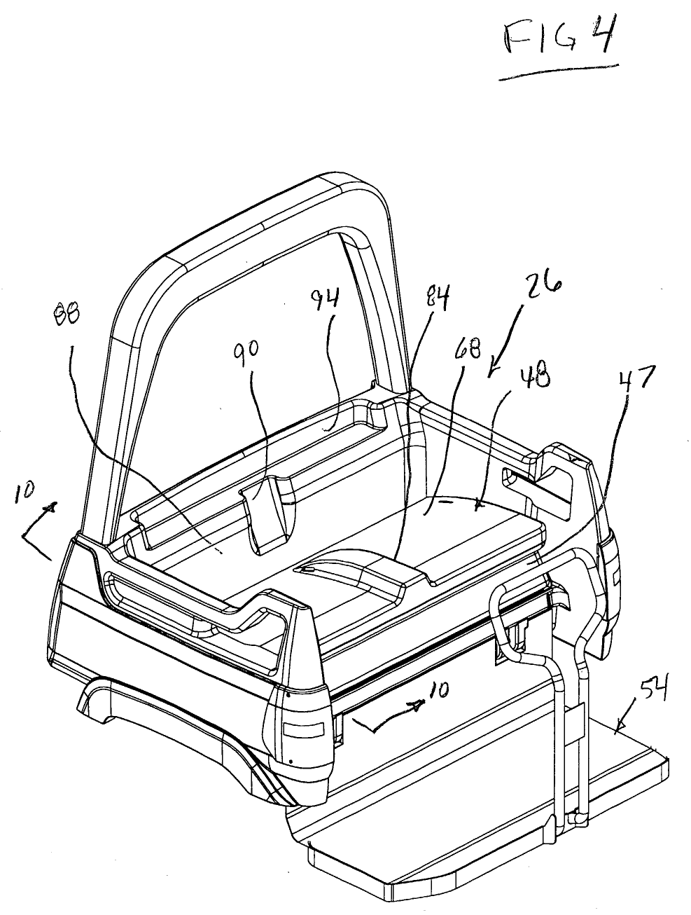

FIG. 4 illustrates the seatback 48 fully folded down onto the seat cushion 47. The support panel 68 includes a central rib 84 that stiffens the support panel 68. A front wall 88 of the cargo area 26 includes a groove 90 which receives a portion of the rib 84. The engagement of the rib 84 and a groove 90 further laterally stabilizes the seatback 48. A convenience tray 94 is also provided in the front wall 88 of the cargo area 26. The tray 94 is accessible from the driver's area 22 and useful to hold small articles.

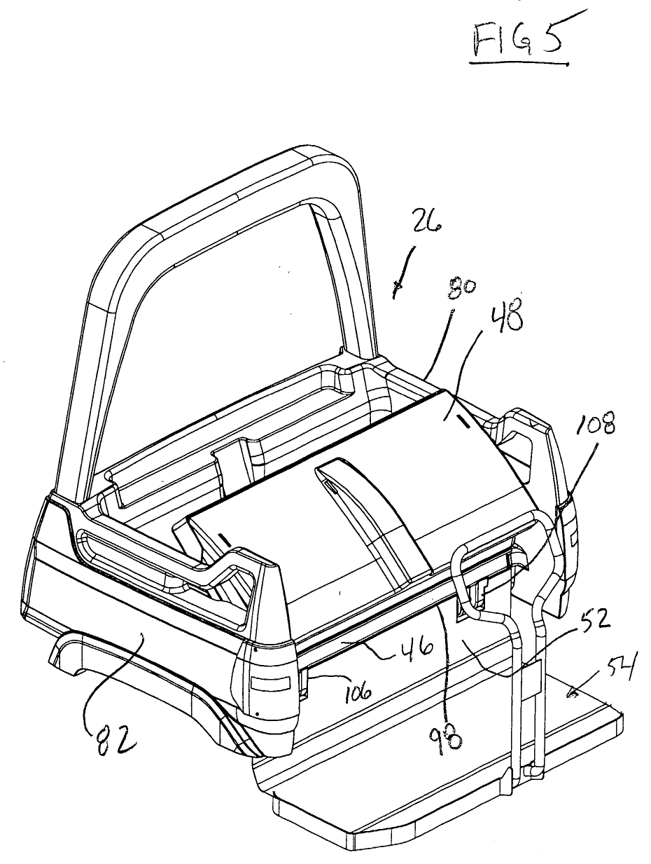

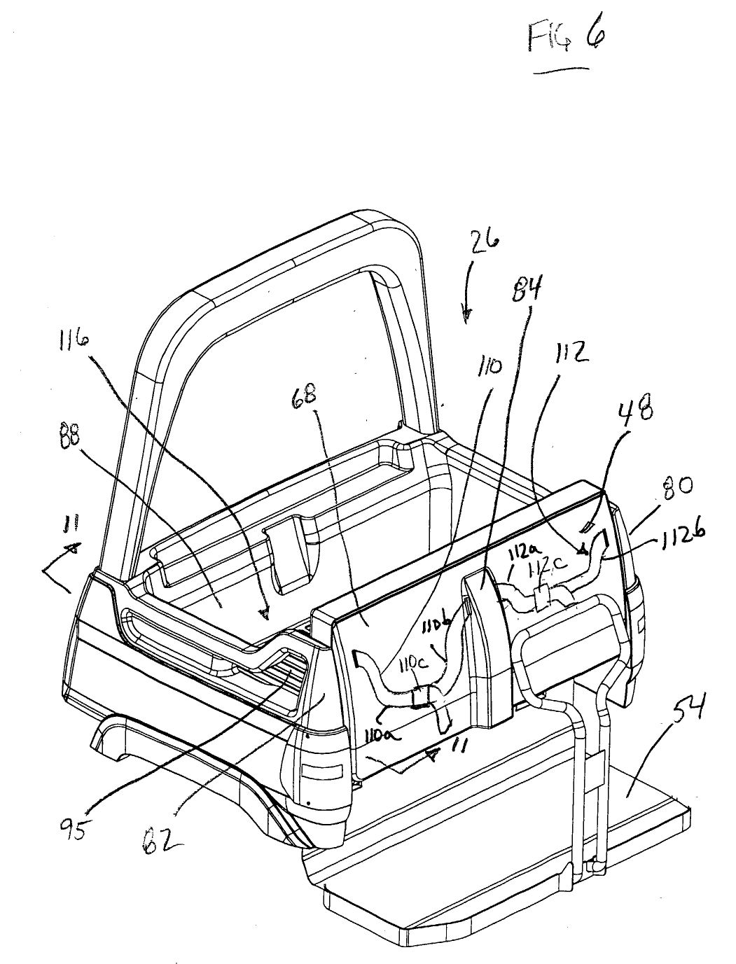

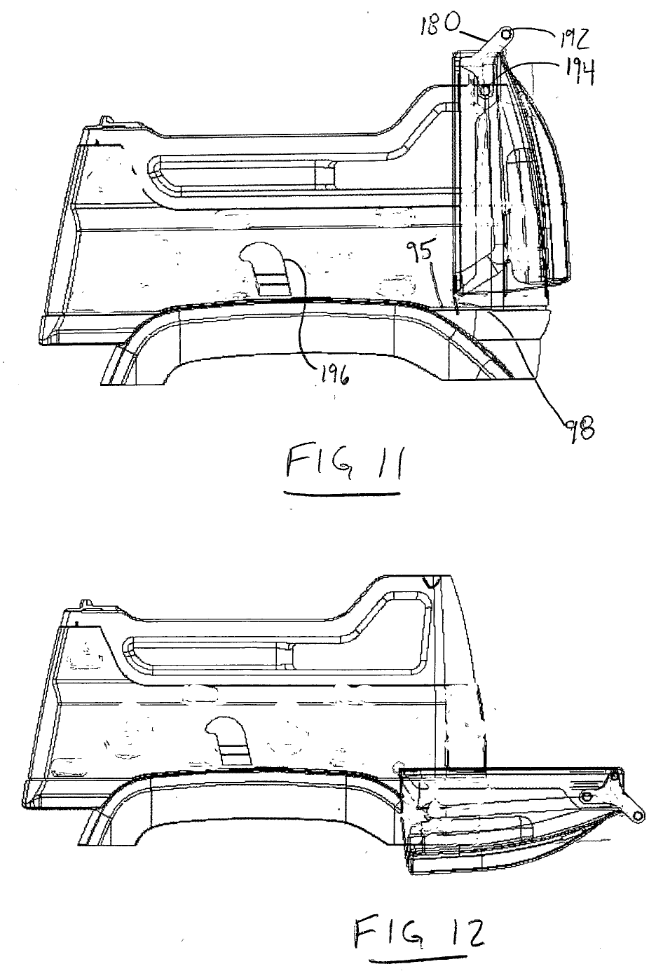

FIG. 5 illustrates a further manipulation of the seat 46 and seatback 48. The platform 60 of the seat 46 is hinged to a cargo area bed or floor 95 (shown in FIG. 6 and 11) by a hinge. Preferably, the platform 60 is hinged to the floor 95 using a plastic living hinge 98. The living hinge 98 can be a separate plastic strip and can extend the width of the platform 60 and can be secured to the platform 60 and to the floor 95 by fasteners (not shown). FIG. 5 illustrates the seat 46 and seatback 48 together as a seat assembly 46, 48 being pivoted about the hinge 98 toward a vertical orientation.

The cargo area 26 is hinged to the chassis via the foot platform 54 by hinge assemblies 106, 108. The cargo area 26 can be pivoted upwardly at a front end thereof to assist in dumping, or cleaning the floor 95 and to expose vehicle systems located beneath the cargo area 26 for service.

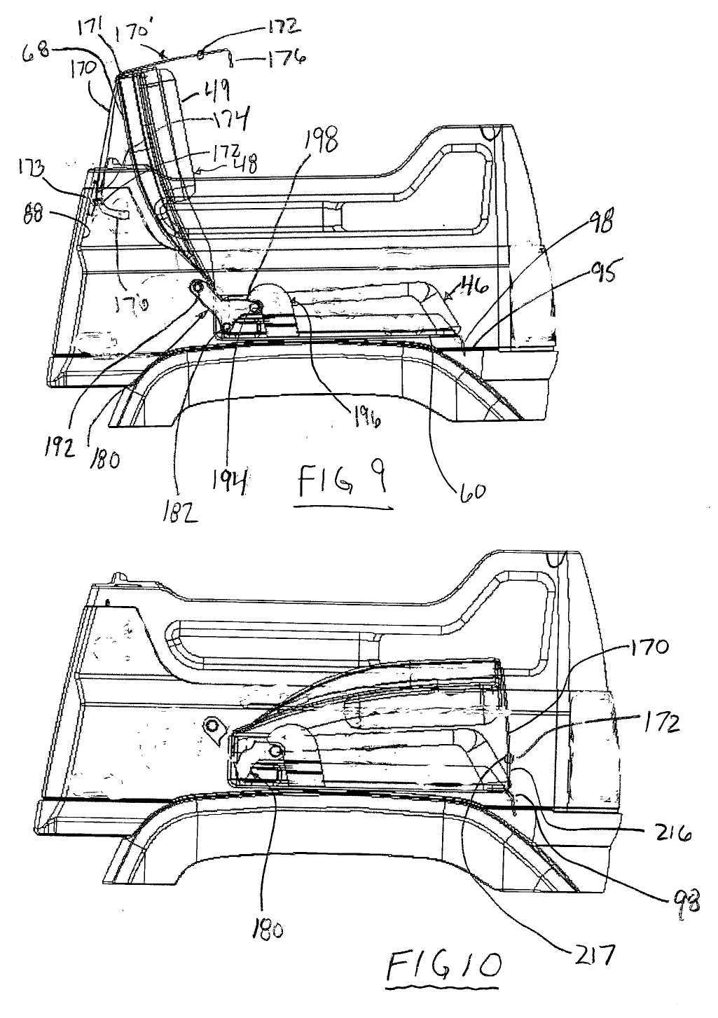

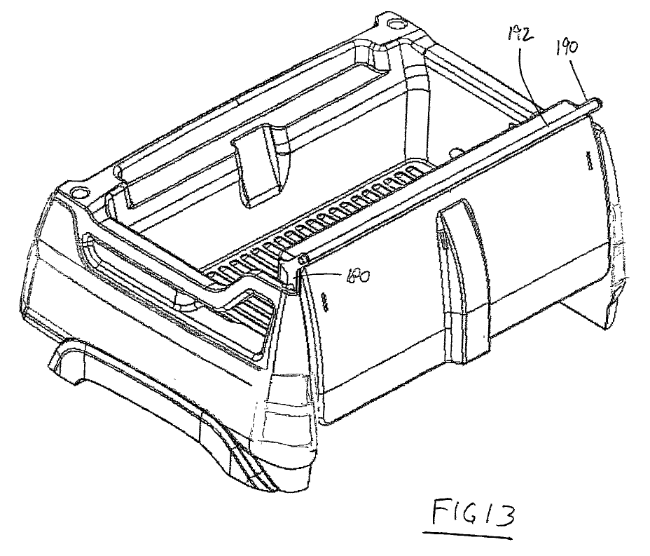

FIG. 6 illustrates the seat and seatback pivoted to a substantially vertical orientation. In this orientation the assembled seat and seatback are latched against the sidewalls 80, 82 by releasable latches, an example of such being described below and illustrated in FIGS. 9-13. Two cargo-restraining strap assemblies 110, 112 are provided on the seatback support panel 68. For simplicity, the strap assemblies 110,112 are only shown in FIG. 6. The strap assemblies 110, 112 can include adjustable straps 110a, 110b; 112a, 112b that can be attached to a surface of the panel 68 or can be automatically retractable within the panel by a spring mechanism (not shown) when not in use. The strap pairs 110a, 110b; 112a, 112b can include a length adjustment buckle 110c, 112c or other device to snugly encircle and hold a golf bag or other cargo. The rib 84 can function to separate two golf bags or other cargo arranged vertically side-by-side. For example, two golf bags can be supported on the foot platform 54, leaned against the support panel 68 and the rib 84, and restrained by the straps 110, 112.

The vertically arranged seat assembly 46, 48 exposes the cargo area floor 95 between the seat assembly 46, 48 and the front wall 88, forming an open top, enclosed cargo area 116.

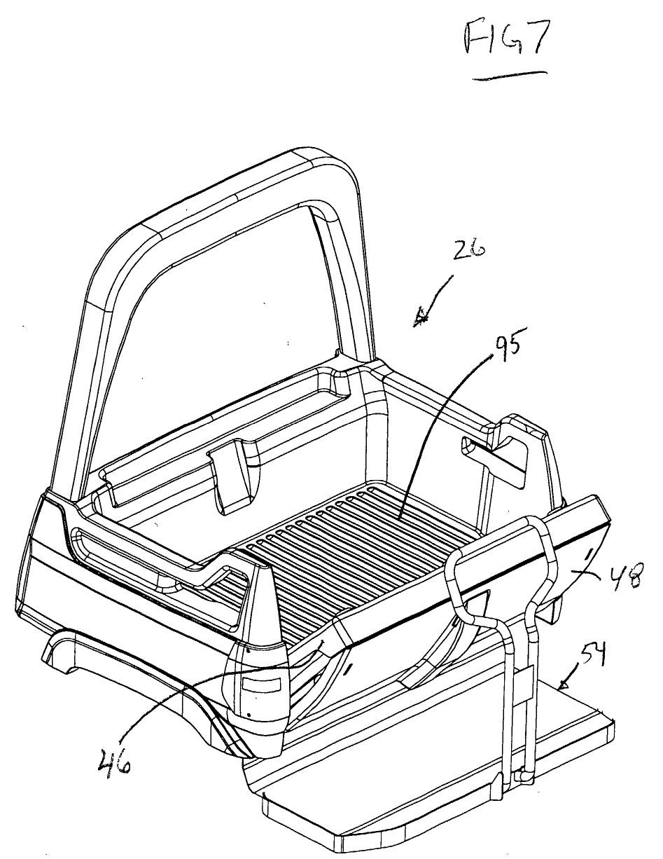

FIG. 7 illustrates the cargo area 26 with the seat assembly 46, 48 further pivoted about the hinge 98 toward a horizontal orientation.

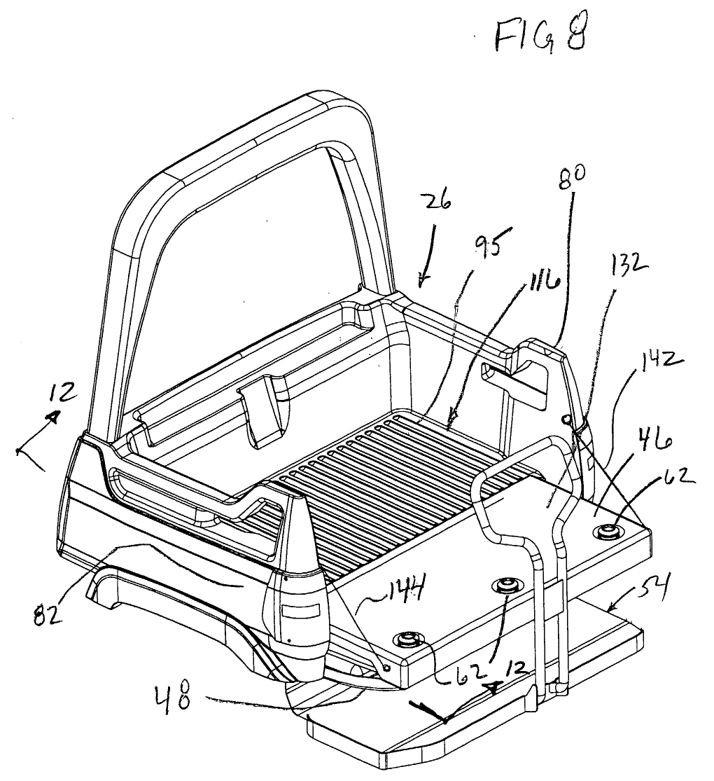

FIG. 8 illustrates the seat assembly 46, 48 completely folded down to a horizontal orientation with the seat 46 now above the seatback 48. A bottom surface of the seat 46 is exposed showing the resilient elements 62. During travel in the position shown in FIG. 1, the elements 62 are supported directly on the floor 95. The floor 95 includes ribs to increase strength and toughness of the cargo area 116 to avoid denting. In the position shown in FIG. 8, a back side 132 of the seat 46 increases the effective length of the cargo area 116 and acts as a cargo area extension. A pair of knee-brace rods or straps 142, 144 can be provided to add strength to the otherwise cantilevered assembly 46, 48. The straps 142, 144 can be attached to the sidewalls 80, 82 respectively. The straps 142, 144 can be separable from the seat 46 so that the seat can be folded back to the position of FIG. 1.

FIGS. 9-13 illustrate a latching arrangement useful to accomplish and hold the range of positions and configurations of the cargo area 26 heretofore illustrated and described.

In FIG. 9, the seatback 48 is in an upright position. The seatback 48 is held in this position by at least one strap 170 having an end 171 fastened to a top of the seatback support 68. A snap fastener 172 is located near a respective opposite end of the strap 170. The snap fastener 172 engages a mating snap fastener 173 that is fastened to a short strap 174. The short strap 174 is secured to the front wall 88 of the cargo area 26. A handle strap 176 is provided for manually disengaging the snap fastener 172 to release the strap 170 from the short strap 174. The strap 170 is also shown in the released position as marked as 170′.

A Y-shaped bracket 180 is fixed to the support platform 60 of the seat 46 at a pivot point 182. The pivot point 182 allows a resilient rotation of the bracket 180 and/or a resilient downward movement of the pivot point 182 with respect to the support platform 60. In this regard, appropriate torsion and support springs are provided within the seat 46, which bias the bracket 182 to its latching position. An identical Y-shaped bracket 190 is arranged in mirror image fashion on the other side of the support platform 60 (see FIG. 9A). A handle rod 192 extends between, and is fixed to, the brackets 180, 190 (see FIG. 9A). A tubular lug 194 extends from a rear lobe of each of the brackets 180, 190. A substantially hook-shaped catch 196, in the form of a thin plate is fixed to the cargo area floor 95 and is positioned to have a concavity or overhang portion 198 that engages the lug 194 of the bracket 180.

As illustrated in FIG. 9A, an identical hook shaped catch 204 is arranged on an opposite side of the support platform 60 to engage the lug 194 of the bracket 190. The arrangement of the hook shaped catches 196, 204 which engage the brackets 180, 190 holds the seat 46 down onto the floor 95.

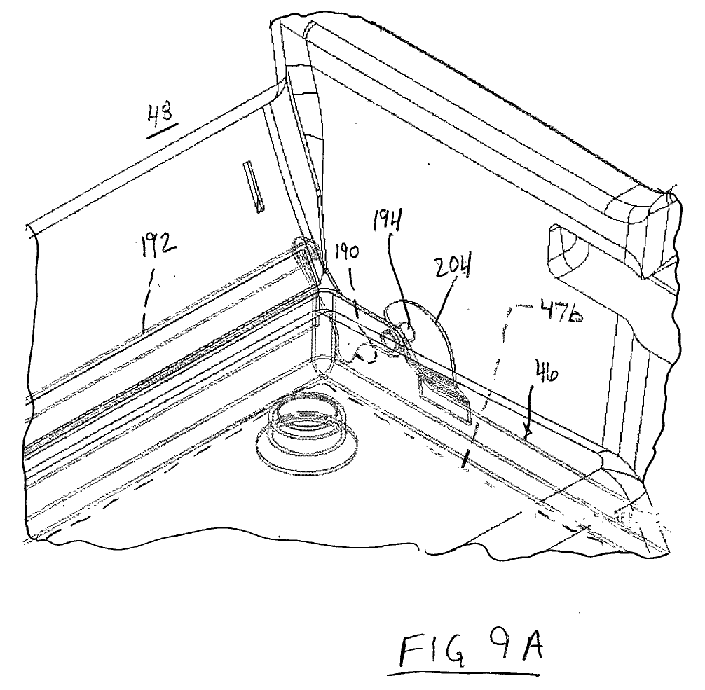

FIG. 10 illustrates the seatback 48 folded down onto the seat 46. The strap 170 can now be engaged to a short strap 216 fixed to and extending from the floor 95. The short strap 216 can have a compatible fastener 217, to engage the fastener 172 to hold the seatback 48 and seat 46 together.

To position the seatback 48 and seat 46 together to a vertical position to expose the floor 95, the handle rod 192 is depressed downwardly. The brackets 180, 190 will pivot and/or move downwardly, against resilient force of the torsion and support seat springs (not shown) until the lugs 194 of the brackets 180, 190 escape the respective catches 198, 204. The seatback 48 and seat 46 can now be rotated upwardly about the hinge 98 to the vertical position shown in FIG. 11.

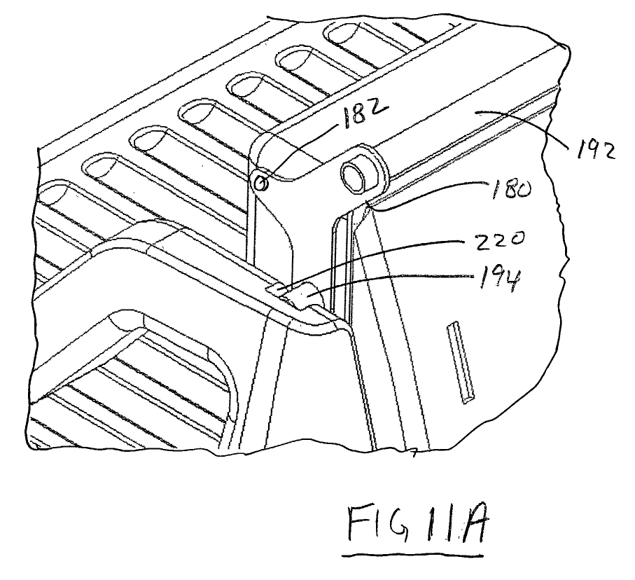

As illustrated in FIGS. 11 and 11A, the lugs 194 snap into slots or depressions 220 formed into the respective cargo area sidewalls 80, 82. The slots 220 act to hold the seat assembly 46, 48 upright. To release the seat assembly 46, 48 from the position shown in FIG. 11, the handle rod 192 is pulled up or forward to pivot the brackets 180,190 about the points 182 to allow the lugs 194 to escape the depressions 220. The seat assembly 46, 48 can then be returned to the previously described position or folded down as per FIG. 12.

To fold the seat assembly 46, 48 down flat to an extended floor position as shown in FIGS. 8 and 12, the handle rod 192 is pulled up or forward to pivot the brackets 180,190 about the points 182 to raise the lugs 194 out of the slots 220. The seat assembly 46, 48 can then be pivoted rearward.

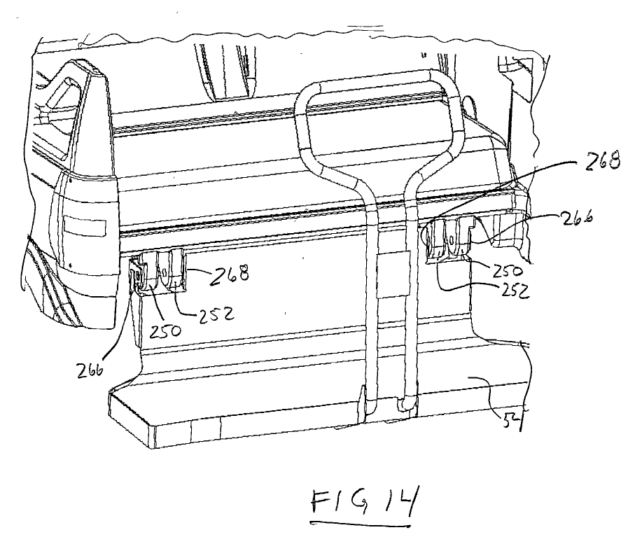

FIG. 14 illustrates the cargo area 26 mounted to the platform 54. The platform 54 is fixedly secured to the chassis 36 of the vehicle. The cargo area 26 is pivotally mounted to the platform 54 by the hinge assemblies 106,108 such that the cargo area 26 can be pivoted up at the front end thereof to assist in dumping and cleaning the cargo area or to expose components located beneath the cargo area for service. The hinge assemblies 106, 108 each include two lobes 250, 252 arranged as a pair mounted to the cargo area 26, and two lugs 266, 268 arranged as a pair mounted to the platform 54, which face outside faces of the lobes 250, 252. Each of the lobes 250, 252 and lugs 266, 268 has a center hole for the receipt of a hinge pin (not shown). Once the hinge pin is inserted through the lobes and lugs on each side of the cargo area 26 and platform 54, the cargo area is pivotally mounted to the foot platform 54.

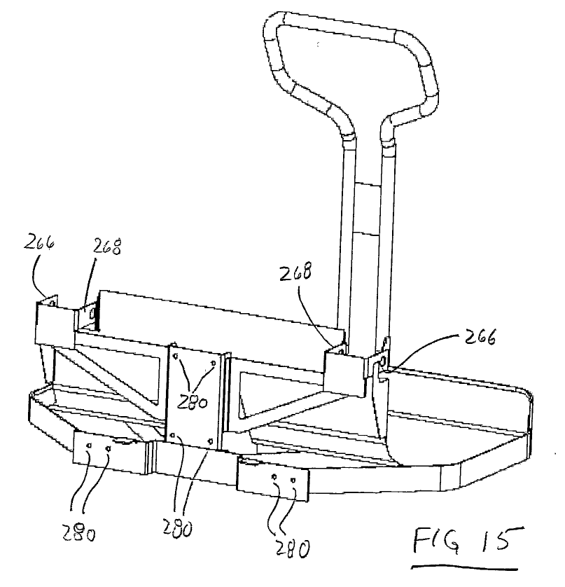

FIG. 15 illustrates a backside of the platform 54. Eight attachment holes 80 are provided for fasteners (not shown) to rigidly secure the platform 54 to the vehicle chassis 36. The two pair of lugs 266, 268 rotationally mount the cargo area 26 to the platform 54.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

The invention claimed is:

1. A utility vehicle comprising:
a chassis;
a powertrain;
a plurality of wheels, at least one of which is driven by the powertrain; and
a rear mounted cargo area, the cargo area comprising a generally horizontal seat and an associated seatback, a floor for supporting cargo, and a cargo-restraining structure for preventing cargo from tipping.

2. The utility vehicle according to claim 1, wherein said seatback is pivotal to be folded down onto said seat, and said seat and seatback are pivotal about 90 degrees to form said cargo-restraining structure, and about 180 degrees to form an extension of said floor.

3. The utility vehicle according to claim 2, wherein when said seat and seatback are pivoted about 90 degrees, a cargo-holding area is formed in front of said cargo-restraining structure.

4. The utility vehicle according to claim 1, wherein said cargo area comprises a foot platform below said seat adjacent to a rear end portion of said vehicle, and a skirt panel extending substantially vertically from said foot platform up to said floor, and said seat is supported on said floor.

5. The utility vehicle according to claim 1, wherein said seat is hinged to said floor along a rear end portion of said floor.

6. The utility vehicle according to claim 1, wherein said seatback is hinged to said seat.

7. The utility vehicle according to claim 1, wherein when said seat and seatback are rotated together about 90 degrees, said floor is exposed.

8. The utility vehicle according to claim 1, wherein a bottom surface of said seat, when rotated about 180 degrees from said normal position comprises an extension of said floor.

9. The utility vehicle according to claim 8, comprising angled straps extending from side walls of said cargo area to opposite sides of said floor extension.

10. The utility vehicle according to claim 1, wherein said cargo-restraining structure comprises said seatback, said front surface of said seatback comprising a contoured golf bag supporting surface and further comprising golf bag restraining straps engaged to said supporting surface.

11. The utility vehicle according to claim 1, further comprising a support bar extending vertically from said foot platform.

12. The utility vehicle according to claim 1, wherein said cargo-restraining structure comprises said seatback, said front surface of said seatback comprising a cargo-supporting surface and further comprising cargo-restraining straps engaged to said supporting surface.

13. The utility vehicle according to claim 1, wherein said cargo area is convertible between three configurations: a first configuration that includes said seatback facing rearward, a second configuration that includes said seatback positioned generally vertically and displaced rearward of its position in said first configuration, and a third configuration wherein said seat and seatback are oriented horizontally, said seat and seatback displaced rearward of their position in said first configuration, said first configuration providing a passenger seat, said second configuration providing said cargo-restraining structure and said third configuration providing an extended, open back cargo area.

14. The utility vehicle according to claim 13, comprising a first latch arrangement for latching said seat in said first configuration and a second latch arrangement for latching said seatback in said second configuration.

15. A method of converting a rear-facing seat of a utility vehicle to multiple uses, comprising the steps of:
providing a normally horizontal seat with a normally rear-facing seatback;
folding said seatback down on said seat and folding up said seat and seatback together about 90 degrees to expose a floor area;
locking the seat and seatback at about 90 degrees and providing at least one cargo restraining strap on a rearward facing side of the seatback;
folding the seat and seatback down in a direction away from the floor to orient a backside of the seat horizontally, facing upwardly to form an extension to said floor.

16. In a utility vehicle, the improvement comprising:
a three-position member wherein said member is pivotal from a first position comprising a rearward facing seatback to a second position forming a cargo-retaining wall and then to a third position forming part of an extended floor.

17. The improvement according to claim 13, wherein when said member is in said second position, an enclosed, open top cargo area is formed adjacent to the cargo-retaining wall.
